(19) United States
(12) Patent Application Publication
(10) Pub. No.: US 2025/0337199 A1
(43) Pub. Date: Oct. 30, 2025

(54) SOCKET CONNECTOR HAVING LOSSY INSERTS

(71) Applicants: TE Connectivity Solutions GmbH, Schaffhausen (CH); Tyco Electronics Japan G.K., Kawasaki-Shi (JP)

(72) Inventors: Chad William Morgan, Carneys Point, NJ (US); Hirotate Kadobayashi, Kawasaki-Shi (JP)

(21) Appl. No.: 18/645,574

(22) Filed: Apr. 25, 2024

(51) Int. Cl. H01R 13/6471

(52) U.S. Cl. CPC H01R 13/6471

(57) ABSTRACT

A socket connector includes a substrate having contact channels between upper and lower surfaces and pockets between the upper and lower surfaces between corresponding contact channels. The socket connector includes socket contacts received in corresponding contact channels. Each socket contact includes a contact body, an upper mating element extending to the upper surface to interface with a first electrical component, and lower mating element extending to the lower surface to interface with a second electrical component. The socket connector includes lossy inserts received in the pockets manufactured from lossy material capable of absorbing electrical resonance propagating through the substrate. The lossy inserts are separate and discrete from the substrate and are attached to the substrate in the pockets in proximity to the socket contacts.

### BACKGROUND OF THE INVENTION

The subject matter herein relates generally to data communication systems.

Electrical interconnects are used to connect two opposing electronic devices. For instance, electrical interconnects may be provided between two circuit boards or a circuit board and another electronic device or pluggable module to transmit data and/or power therebetween. Some known electrical interconnects use dual compression socket connectors to define separable mating interfaces at both the upper interface and the lower interface for repeated mating and unmating of the components. As the data rates of communication systems increase, conventional electrical interconnects are unable to meet the demands for electrical performance of the systems.

A need remains for a socket connector that can perform at higher data rates than conventional interconnects in a reliable manner.

### BRIEF DESCRIPTION OF THE INVENTION

In one embodiment, a socket connector is provided and includes a substrate having an upper surface and a lower surface. The substrate includes contact channels between the upper and lower surfaces. The substrate includes pockets between the upper and lower surfaces. The pockets are located between corresponding contact channels. The socket connector includes socket contacts received in corresponding contact channels. Each socket contact includes a contact body, an upper mating element, and a lower mating element. The upper mating element extends to the upper surface to interface with a first electrical component. The lower mating element extends to the lower surface to interface with a second electrical component. The socket connector includes lossy inserts received in the pockets. The lossy inserts are manufactured from lossy material capable of absorbing electrical resonance propagating through the substrate. The lossy inserts are separate and discrete from the substrate and are attached to the substrate in the pockets in proximity to the socket contacts.

In another embodiment, a socket connector is provided and includes a substrate having an upper surface and a lower surface. The substrate includes contact channels between the upper and lower surfaces. The substrate includes pockets between the upper and lower surfaces. The pockets are located between corresponding contact channels. The socket connector includes socket contacts received in corresponding contact channels. Each socket contact includes a contact body, an upper mating element, and a lower mating element. The upper mating element extends to the upper surface to interface with a first electrical component. The lower mating element extends to the lower surface to interface with a second electrical component, wherein the socket contacts include signal socket contacts and ground socket contacts. The socket contacts are arranged in pair groups. Each pair group having a pair of the signal socket contacts surrounded by ground socket contacts forming a shield box around the pair of signal socket contacts. The socket connector includes lossy inserts received in the pockets. The lossy inserts are manufactured from lossy material capable of absorbing electrical resonance propagating through the substrate. The lossy inserts are separate and discrete from the substrate and are attached to the substrate in the pockets in proximity to the socket contacts, wherein the lossy inserts are in proximity to each pair group.

In a further embodiment, a socket connector is provided and includes a substrate having an upper surface and a lower surface. The substrate has a molded body molded from a low loss dielectric material. The substrate includes contact channels between the upper and lower surfaces. The substrate includes pockets between the upper and lower surfaces. The pockets are located between corresponding contact channels. The socket connector includes socket contacts received in corresponding contact channels. Each socket contact includes a contact body, an upper mating element, and a lower mating element. The upper mating element extends to the upper surface to interface with a first electrical component. The lower mating element extends to the lower surface to interface with a second electrical component. The socket connector includes lossy inserts molded in place in the corresponding pockets of the substrate. The lossy inserts are manufactured from lossy material capable of absorbing electrical resonance propagating through the substrate. The lossy inserts are located in proximity to the socket contacts.

### BRIEF DESCRIPTION OF THE DRAWINGS

FIG. 1 illustrates an electronic assembly including a socket connector in accordance with an exemplary embodiment.

FIG. 2 is a cross-sectional view of the electronic assembly in accordance with an exemplary embodiment showing the socket connector connected between the first and second electrical components.

FIG. 3 is a top view of a portion of the socket connector in accordance with an exemplary embodiment.

FIG. 4 is a front perspective view of the socket contact in accordance with an exemplary embodiment.

FIG. 5 is a rear perspective view of the socket contact in accordance with an exemplary embodiment.

FIG. 6 is a top view of a portion of the socket connector in accordance with an exemplary embodiment.

FIG. 7 is a top view of a portion of the socket connector in accordance with an exemplary embodiment.

FIG. 8 is a top view of a portion of the socket connector in accordance with an exemplary embodiment.

FIG. 9 is a graph illustrating return loss of the socket connector including the resonance control structure showing limit lines for an exemplary socket connector in accordance with an exemplary embodiment.

FIG. 10 is a graph illustrating insertion loss of the socket connector including the resonance control structure showing limit lines for an exemplary socket connector in accordance with an exemplary embodiment.

FIG. 11 is a graph illustrating common mode conversion to insertion loss ration (SCD21) of the socket connector including the resonance control structure in accordance with an exemplary embodiment.

### DETAILED DESCRIPTION OF THE INVENTION

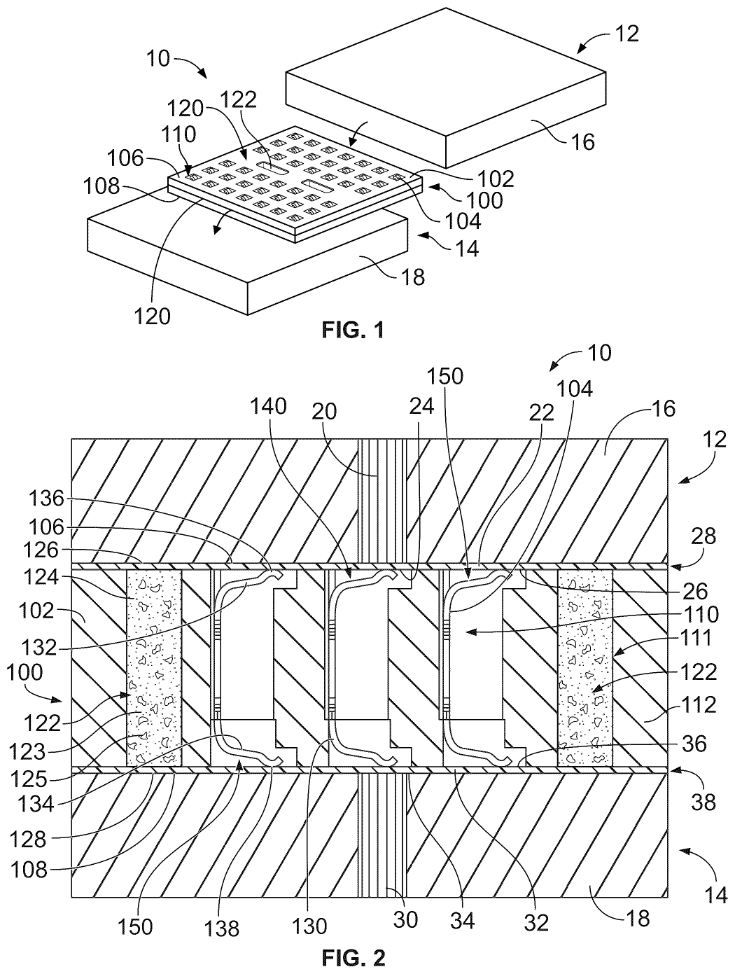

FIG. 1 illustrates an electronic assembly 10 including a socket connector 100 in accordance with an exemplary embodiment. The socket connector 100 is used to electrically connect a first electrical component 12 and a second electrical component 14. In an exemplary embodiment, the first electrical component 12 includes a first circuit board 16 and the second electrical component 14 includes a second circuit board 18. The socket connector 100 is an interposer between the first circuit board 16 and the second circuit board 18. The socket connector 100 is electrically connected between the first circuit board 16 and the second circuit board 18.

In an exemplary embodiment, the socket connector 100 is compressible between the first circuit board 16 and the second circuit board 18. For example, the socket connector 100 may include a land grid array (LGA) interface with the first circuit board 16 and/or the second circuit board 18. In an exemplary embodiment, the socket connector 100 includes a dual compressive interface that is compressible against the first circuit board 16 and compressible against the second circuit board 18. The upper interface and/or the lower interface of the socket connector 100 may be a separable mating interface. In alternative embodiments, the upper interface and/or the lower interface may be a solder interface, such as a ball grid array. In various embodiments, the first circuit board 16 may be part of an electrical component, such as a chip, an ASIC, a processor, a memory module or other component.

The socket connector 100 includes a substrate 102 holding a plurality of socket contacts 104. In an exemplary embodiment, the socket contacts 104 are stamped and formed contacts. The substrate 102 extends between an upper surface 106 and a lower surface 108. The socket contacts 104 are received in corresponding contact channels 110 to pass through the substrate 102 between the upper surface 106 and the lower surface 108.

In an exemplary embodiment, the substrate 102 includes a resonance control structure 120 embedded in the substrate 102. The resonance control structure 120 provides resonance suppression. For example, the resonance control structure 120 dampens resonance through the substrate 102, such as between and/or around the various signal paths through the socket connector 100. The resonance control structure 120 is used to improve electrical performance of the socket connector 100. The resonance control structure 120 improves performance and signal integrity by controlling insertion loss, return loss, near-end crosstalk, far-end crosstalk, and the like to improve electrical performance of the socket connector 100. The resonance control structure 120 may be provided in spaces between socket contacts 104, such as in spaces between pair groups of the socket contacts 104. In an exemplary embodiment, the resonance control structure 120 is an internal resonance control structure located at an internal area of the substrate 102. The resonance control structure 120 may be provided at the upper surface 106 and/or at the lower surface 108. In an exemplary embodiment, the resonance control structure 120 includes lossy inserts 122 incorporated into the substrate 102. The lossy inserts 122 are made from a lossy material, such as a lossy plastic material.

The resonance control structure 120 is placed in strategic locations, such as relative to the signal socket contacts. The resonance control structure 120 is low cost, such as compared to providing additional stamped and formed ground contacts. The resonance control structure 120 is easy to manufacture. For example, the lossy inserts 122 may be molded in place in the substrate 102 or co-molded with the substrate, such as by a two shot molding process. In other embodiments, the lossy inserts 122 may be pre-molded and inserted into openings or pockets in the substrate 102. The resonance control structure 120 does not impact the mating or assembly of the electronic assembly 10. For example, the resonance control structure 120 does not increase mating forces of the circuit boards 16, 18 with the socket connector 100, which is in contrast to conventional systems that add additional ground contacts that increase the mating forces.

FIG. 2 is a cross-sectional view of the electronic assembly 10 in accordance with an exemplary embodiment showing the socket connector 100 connected between the first and second electrical components 12, 14. In an exemplary embodiment, the first electrical component 12 includes the first circuit board 16 and the second electrical component 14 includes the second circuit board 18. During assembly, the socket connector 100 is stacked between the first and second electrical components 12, 14 to electrically connect the first and second circuit boards 16, 18.

The first circuit board 16 is located above the socket connector 100 and may be referred to hereinafter as upper circuit board 16. The upper circuit board 16 includes upper signal contacts 20 and upper ground contacts 22, which may be connected to corresponding traces, vias, or other circuits of the first circuit board 16. The upper signal contacts 20 are defined by one or more circuits of the upper circuit board 16, such as traces, vias, pads, and the like. In an exemplary embodiment, the upper signal contact 20 includes a signal contact pad 24 at the bottom surface of the upper circuit board 16 configured to be electrically connected to the corresponding socket contact 104 of the socket connector 100. The upper ground contacts 22 are defined by one or more circuits of the upper circuit board 16, such as traces, vias, pads, and the like. In an exemplary embodiment, the upper ground contact 22 includes a ground contact pad 26 at the bottom surface of the upper circuit board 16 configured to be electrically connected to the corresponding socket contact 104 of the socket connector 100. In an exemplary embodiment, the upper circuit board 16 includes an upper ground plane 28 electrically connecting each of the upper ground contacts 22. In various embodiments, the upper ground plane 28 may be provided at the bottom surface of the upper circuit board 16. Optionally, multiple upper ground planes 28 may be provided at different layers of the upper circuit board 16.

The second circuit board 18 is located below the socket connector 100 and may be referred to hereinafter as lower circuit board 18. The lower circuit board 18 includes lower signal contacts 30 and lower ground contacts 32, which may be connected to corresponding traces, vias, or other circuits of the first circuit board 16. The lower signal contacts 30 are defined by one or more circuits of the lower circuit board 18, such as traces, vias, pads, and the like. In an exemplary embodiment, the lower signal contact 30 includes a signal contact pad 34 at the top surface of the lower circuit board 18 configured to be electrically connected to the corresponding socket contact 104 of the socket connector 100. The lower ground contacts 32 are defined by one or more circuits of the lower circuit board 18, such as traces, vias, pads, and the like. In an exemplary embodiment, the lower ground contact 32 includes a ground contact pad 36 at the top surface of the lower circuit board 18 configured to be electrically connected to the corresponding socket contact 104 of the socket connector 100. In an exemplary embodiment, the lower circuit board 18 includes a lower ground plane 38 electrically connecting each of the lower ground contacts 32. In various embodiments, the lower ground plane 38 may be provided at the top surface of the lower circuit board 18. Optionally, multiple lower ground planes 38 may be provided at different layers of the lower circuit board 18.

The socket connector 100 includes the substrate 102 and the socket contacts 104. In an exemplary embodiment, the socket contacts 104 are stamped and formed contacts configured to be stitched, pressed, or otherwise loaded into the corresponding contact channels 110 of the substrate 102. The socket contacts 104 extend to the upper surface 106 to interface with the upper circuit board 16 and extend to the lower surface 108 to interface with the lower circuit board 18. In an exemplary embodiment, the socket contacts 104 have separable mating interfaces at the upper and lower ends to interface with the upper and lower circuit boards 16, 18. The socket contacts 104 are compressible such that the upper and lower ends of the socket contacts 104 are deflected when interfacing with the upper and lower circuit boards 16, 18. As such, the socket contacts 104 are spring biased against the upper and lower circuit boards 16, 18 to maintain electrical connection with the upper and lower circuit boards 16, 18.

In an exemplary embodiment, the substrate 102 includes a dielectric structure 112 having one or more dielectric layers. The dielectric structure 112 is a low loss dielectric material. In an exemplary embodiment, dielectric structure 112 is a molded body, such as being molded from a polymer material. The dielectric structure 112 may be nylon, LCP, PBT, and the like. The dielectric structure 112 may use glass reinforcement fibers, which may be in a random orientation. During the molding process, the substrate 102 includes openings or pockets that define the contact channels 110. The substrate 102 includes additional openings or pockets 111 that receive the lossy inserts 122. The pockets 111 may be separate or spaced apart from the contact channels 110. For example, the dielectric structure 112 of the substrate 102 surrounds the contact channels 110 and the pockets 111. The dielectric structure 112 of the substrate 102 is located between the contact channels 110 and the pockets 111. As such, the lossy inserts 122 do not directly contact the socket contacts 104.

In an exemplary embodiment, the socket contacts 104 are stamped and formed contacts. Each socket contact 104 includes a contact body 130, an upper mating element 132 extending from the top of the contact body 130, and a lower mating element 134 extending from the bottom of the contact body 130. The mating elements 132, 134 are deflectable relative to the contact body 130. The contact body 130 is configured to be stitched or otherwise loaded into the substrate 102. The contact body 130 may be secured to the dielectric structure 112. For example, barbs or other features may engage the dielectric structure 112 to hold the socket contact 104 in the substrate 102 by an interference fit. The upper mating element 132 extends to the upper surface 106 to interface with the first electrical component 12. The upper mating element 132 includes an upper mating interface 136 configured to engage the upper circuit board 16 (for example, to engage the corresponding contact pad at the bottom of the upper circuit board 16). The lower mating element 134 extends to the lower surface 108 to interface with the second electrical component 14. The lower mating element 134 includes a lower mating interface 138 configured to engage the lower circuit board 18 (for example, to engage the corresponding contact pad at the top of the lower circuit board 18).

In an exemplary embodiment, the upper mating element 132 is an upper mating beam and may be referred to hereinafter as an upper mating beam 132. In an exemplary embodiment, the lower mating element 134 is a lower mating beam and may be referred to hereinafter as a lower mating beam 134. The mating beams 132, 134 may be deflectable spring beams. However, other types of mating elements may be used in alternative embodiments. For example, the socket contacts 104 may be conductive elastomeric columns having upper portions defining the upper mating elements 132 and lower portions defining the lower mating elements 134.

In an exemplary embodiment, the socket contacts 104 include signal socket contacts 140 and ground socket contacts 150. The signal socket contacts 140 are configured to be electrically connected to corresponding signal contacts 20, 30 of the upper and lower circuit boards 16, 18. The ground socket contacts 150 are configured to be electrically connected to corresponding ground contacts 22, 32 of the upper and lower circuit boards 16, 18. The ground socket contacts 150 provide electrical shielding for the signal socket contacts 140. In various embodiments, the signal socket contacts 140 are arranged in pairs. The ground socket contacts 150 surround corresponding pairs of the signal socket contacts 140.

In an exemplary embodiment, the lossy insert 122 includes an insert body 124 extending at least partially between an upper surface 126 and a lower surface 128. The lossy insert 122 is manufactured from lossy material capable of absorbing electrical resonance propagating through the substrate 102. The lossy inserts 122 are separate and discrete from the substrate 102 and configured to be attached to the substrate 102 in the pockets 111 in proximity to the socket contacts 104. In an exemplary embodiment, the lossy inserts 122 are embedded in the substrate 102. For example, the upper and lower surfaces 126, 128 of the lossy inserts 122 may be coplanar with the upper and lower surfaces 106, 108 of the substrate 102. The upper and lower surfaces 126, 128 of the lossy inserts 122 may be recessed interior of the upper and lower surfaces 106, 108. As such, the lossy inserts 122 do not interfere with compression of the mating beams 132, 134 during mating with the circuit boards 12, 14.

The lossy inserts 122 include lossy material providing electric and/or magnetic loss through a portion of the substrate 102. In an exemplary embodiment, the lossy inserts 122 are manufactured from a lossy material For example, the lossy inserts 122 include a dielectric binder material 123 and conductive fillers 125 dispersed within the dielectric binder material 123 in various embodiments. In various embodiments, the conductive fillers 125 may be at an amount of 50% or more by volume.

In an exemplary embodiment, the lossy inserts 122 includes lossy material configured to absorb at least some resonance that propagates along the current paths defined by the signal socket contacts 140 and/or the ground socket contacts 150 through the substrate 102. The lossy material provides electric and/or magnetic loss through a portion of the substrate 102. The lossy material is able to conduct electrical energy at very low levels. The lossy material is less conductive than traditional conductive material, such as the conductive material of the contacts, and more conductive than the low loss dielectric material of the dielectric structure 112. The lossy material may be designed to provide electrical loss in a certain, targeted frequency range. The lossy material includes the conductive particles or fillers 125 dispersed within the dielectric binder material 123. The dielectric material 123, such as a polymer or epoxy, is used as a binder to hold the conductive particle fillers 125 in place. The conductive particle fillers 125 impart loss that converts the dielectric material to a lossy material. In some embodiments, the lossy material is formed by mixing binder with filler that includes conductive particles. Examples of conductive particles that may be used as a filler to form electrically lossy materials include but are not limited to carbon or graphite formed as fibers, flakes, or other particles. Metal in the form of powder, flakes, fibers, or other conductive particles may also be used to provide suitable lossy properties. Alternatively, combinations of fillers may be used. For example, metal plated (or coated) particles may be used. Silver and nickel may also be used to plate particles. Plated (or coated) particles may be used alone or in combination with other fillers, such as carbon flakes. In some embodiments, the fillers may be present in a sufficient volume percentage to allow conducting paths to be created from particle to particle. For example, when metal fiber is used, the fiber may be present at an amount up to 40% by volume or more. The lossy material may be magnetically lossy and/or electrically lossy. For example, the lossy material may be formed of a binder material with magnetic particles dispersed therein to provide magnetic properties. The magnetic particles may be in the form of flakes, fibers, or the like. Materials such as magnesium ferrite, nickel ferrite, lithium ferrite, yttrium garnet and/or aluminum garnet may be used as magnetic particles. In some embodiments, the lossy material may simultaneously be an electrically-lossy material and a magnetically-lossy material. Such lossy materials may be formed, for example, by using magnetically-lossy filler particles that are partially conductive or by using a combination of magnetically-lossy and electrically-lossy filler particles.

As used herein, the term “binder” encompasses material that encapsulates the filler or is impregnated with the filler. The binder material may be any material that will set, cure, or can otherwise be used to position the filler material. In some embodiments, the binder may be a thermoplastic material such as those traditionally used in the manufacture of communication connectors. The thermoplastic material may be molded, such as molding of the lossy inserts 122 into the desired shape and/or location. However, many alternative forms of binder materials may be used. Curable materials, such as epoxies, can serve as a binder. Alternatively, materials such as thermosetting resins or adhesives may be used.

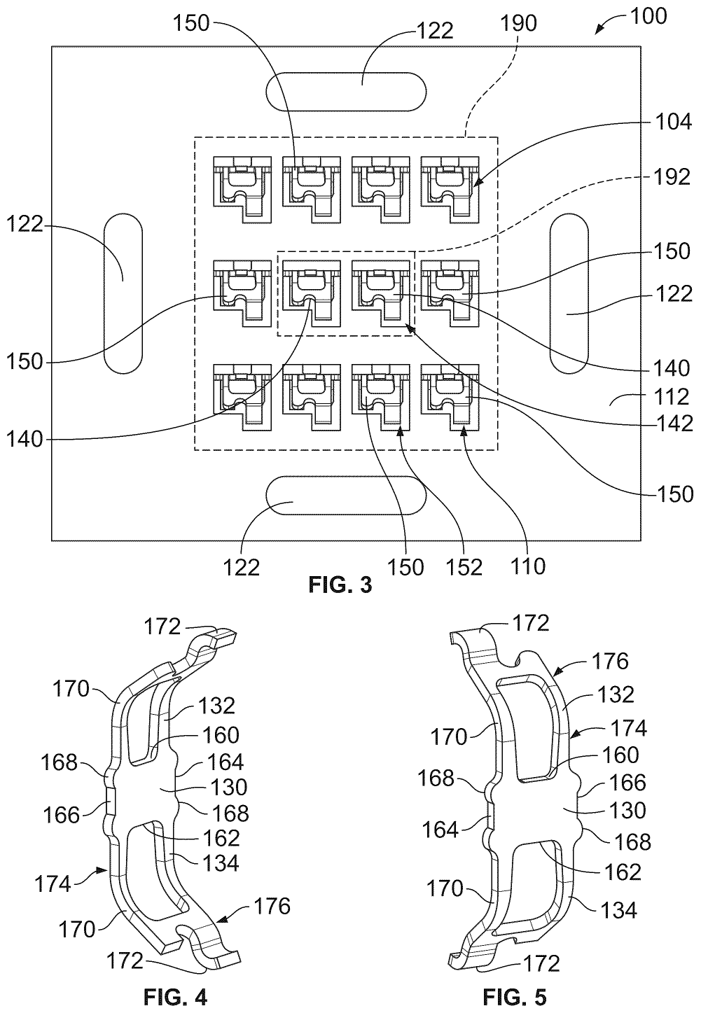

FIG. 3 is a top view of a portion of the socket connector 100 in accordance with an exemplary embodiment. FIG. 4 illustrates an array of the socket contacts 104 showing the socket contacts 104 in a plurality of rows and a plurality of columns. FIG. 3 illustrates a pair group 190. The pair group 190 includes a ring or box of ground socket contacts 150 surrounding a pair 192 of the signal socket contacts 140. For example, the ground socket contacts 150 are located in front of, behind, and on both sides of the pair of signal socket contacts 140. The ground socket contacts 150 electrically isolate each pair of signal socket contacts 140 from every other pair of the signal socket contacts 140. The lossy insert(s) 122 may be arranged on one or more sides of the pair group, such as in front of, behind, and/or on one or both sides of the pair group, such as in one or more of the locations identified in FIG. 3.

The socket contacts 104 are received in corresponding contact channels 110. The contact channels 110 pass through the dielectric structure 112. In an exemplary embodiment, the contact channels 110 include signal contact channels 142 that receive corresponding signal socket contacts 140 and ground contact channels 152 that receive corresponding ground socket contacts 150. In the illustrated embodiment, the signal contact channels 142 are aligned in the rows and the columns with the ground contact channels 152 to position the signal socket contacts 140 in the rows and columns with the ground socket contacts 150. The lossy inserts 122 may be arranged in the rows and/or the columns aligned with the signal contact channels 142 or the ground contact channels 152.

FIG. 4 is a front perspective view of the socket contact 104 in accordance with an exemplary embodiment. FIG. 5 is a rear perspective view of the socket contact 104 in accordance with an exemplary embodiment. In various embodiments, the signal socket contacts 140 and the ground socket contacts 150 are identical. However, in alternative embodiments, the signal socket contacts 140 and/or the ground socket contacts 150 may include different components or features.

The socket contact 104 is a stamped and formed contact stamped from a metal plate or blank material and then formed into a predetermined shape. The socket contact 104 includes the contact body 130 and the upper and lower mating beams 132, 134 extending from the contact body 130. The contact body 130 may be approximately centered along the socket contact 104. For example, the upper and lower mating beams 132, 134 may have similar sizes and/or shapes. The mating beams 132, 134 are cantilevered from the contact body 130 and are deflectable relative to the main contact body 130.

The contact body 130 includes a top 160, a bottom 162, and opposite sides 164, 166. In an exemplary embodiment, the contact body 130 includes barbs 168 extending from the sides 164, 166. The barbs 168 are used to secure the socket contact 104 in the substrate 102 (shown in FIG. 3). In the illustrated embodiment, the barbs 168 are rounded protrusions. The barbs 168 may have other shapes in alternative embodiments, such as triangular shapes configured to pierce or cut into the dielectric material of the substrate 102.

Each mating beam 132, 134 includes an arm 170 and a finger 172 extending from the arm 170. The finger 172 defines a mating interface configured to be mated with the corresponding circuit board. The arm 170 is deflectable. In various embodiments, and the inner portion 174 of the arm 170 is generally coplanar with the contact body 130 and an outer portion 176 of the arm 170 is nonplanar with the contact body 130, such as being angled in a forward direction. The finger 172 extends from the outer portion 176 of the arm 170. The mating beams 132, 134 may have other shapes in alternative embodiments.

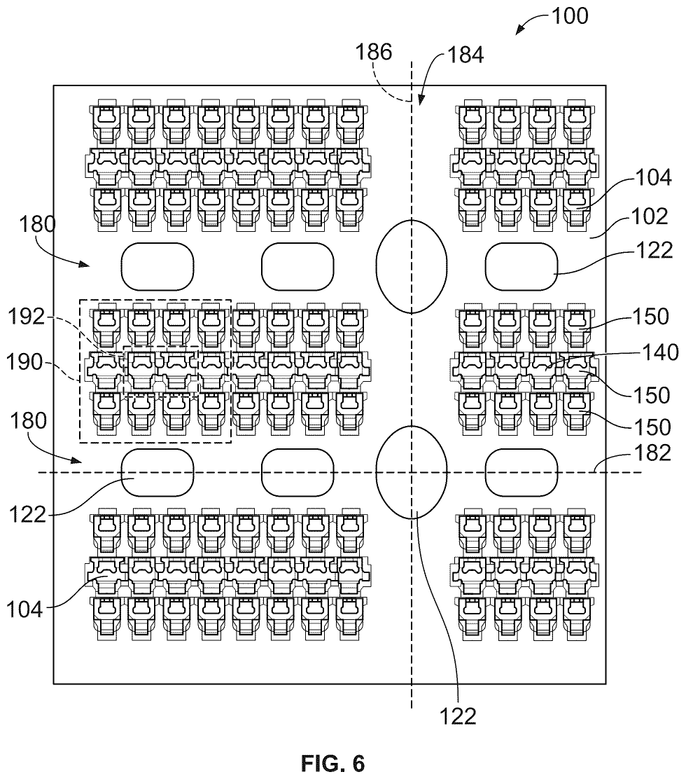

FIG. 6 is a top view of a portion of the socket connector 100 in accordance with an exemplary embodiment. FIG. 6 shows an example layout of the socket contacts 104 and the lossy inserts 122. In an exemplary embodiment, the socket contacts 104 are arranged in rows and columns. The lossy inserts 122 may be arranged between corresponding rows of the socket contacts 104 and/or between corresponding columns of the socket contacts 104.

In an exemplary embodiment, the substrate 102 includes primary gaps 180 extending along a primary axis 182 and secondary gaps 184 extending along a secondary axis 186. The primary gaps 180 extend between corresponding rows of socket contacts 104. The secondary gaps 184 extend between corresponding columns of the socket contacts 104. The lossy inserts 122 are located in the primary gaps 180 and/or in the secondary gaps 184.

In an exemplary embodiment, the socket contacts 104 are arranged in pair groups 190. Each pair group 190 has a pair 192 of the signal socket contacts 140 surrounded by ground socket contacts 150 forming a shield box around the pair 192 of signal socket contacts 140. In the illustrated embodiment, each pair group 190 includes ten of the ground socket contacts 150 forming the shield box around the pair of the signal socket contacts 140. For example, the socket contacts 104 may be arranged in three rows, with the signal socket contacts 140 arranged in the middle row, flanked on each side by corresponding ground socket contacts 150. The two outer rows of contacts are each populated by four of the ground socket contacts 150, aligned with the contacts in the middle row in columns. For example, the three rows of contacts may be in a G-G-G-G/G-S-S-G/G-G-G-G pattern. Some of the pair groups 190 may be stacked immediately adjacent each other (for example, without gaps and lossy inserts 122 therebetween). Some of the pair groups 190 may be separated by the primary gaps 180 and/or the secondary gaps 184. The lossy inserts 122 may be arranged between corresponding pair groups 190, such as in the gaps 180, 184 between the corresponding pair groups 190.

In an exemplary embodiment, the lossy inserts 122 are aligned with the pairs 192 of signal socket contacts 140. For example, the lossy inserts 122 are located in the primary gaps 180 aligned in column with the signal socket contacts 140. The outer rows of ground socket contacts 150 are located between the signal socket contacts 140 and the lossy inserts 122. The lossy inserts 122 may additionally or alternatively be located in the secondary gaps 184 aligned in row with the signal socket contacts 140. The flanking ground socket contacts 150 are located in row between the signal socket contacts 140 and the lossy inserts 122.

In an exemplary embodiment, the lossy inserts 122 are elongated, such as parallel to the primary axis 182 or the secondary axis 186, respectively. For example, the lossy inserts 122 may be oval shaped having parallel sides and curved ends. The lossy inserts 122 may have other shapes in alternative embodiments, such as being rectangular, cylindrical, or having other shapes. In an exemplary embodiment, the lossy inserts 122 may be wide enough to cover (for example, align with) both signal socket contacts 140 of the pair 192. For example, the pair group 190 may have a width and the lossy inserts 122 may have an insert width less than the width of the pair group 190, such as a width approximately as wide as the pair 192 of signal socket contacts 140. Optionally, multiple lossy inserts 122 may be arranged in each primary gap 180 and/or each secondary gap 184. The lossy inserts 122 may be separated by a distance. The distance may be longer than the insert width. Alternatively, the distance may be shorter than the insert width.

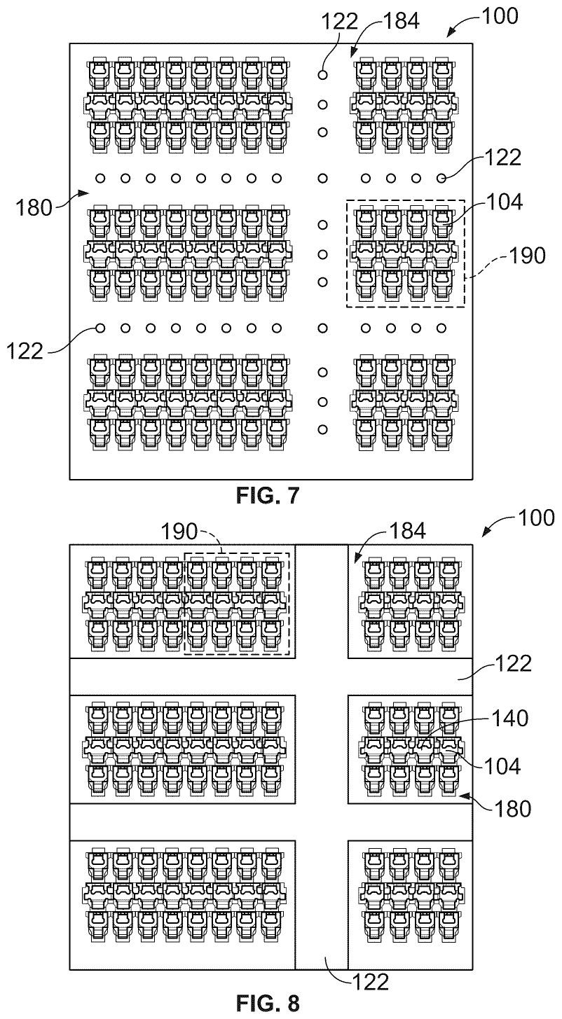

FIG. 7 is a top view of a portion of the socket connector 100 in accordance with an exemplary embodiment. FIG. 7 shows another example layout of the socket contacts 104 and the lossy inserts 122. In the illustrated embodiment, the lossy inserts 122 have a picket fence type of pattern having multiple lossy inserts 122 arranged in rows and/or columns between corresponding pair groups 190. Optionally, the lossy inserts 122 are aligned with each of the rows and/or columns in the corresponding gaps 180, 184. The lossy inserts 122 may be cylindrical inserts. However, the lossy inserts 122 may have other shapes in alternative embodiments. Other arrangements are possible in alternative embodiments, such as only being aligned in the rows/columns having the signal socket contacts 140.

FIG. 8 is a top view of a portion of the socket connector 100 in accordance with an exemplary embodiment. FIG. 8 shows another example layout of the socket contacts 104 and the lossy inserts 122. In the illustrated embodiment, the lossy inserts 122 include elongated rails extending the lengths of the primary gaps 180 and/or the secondary gaps 184. The lossy inserts 122 are continuous, spanning the pair groups 190.

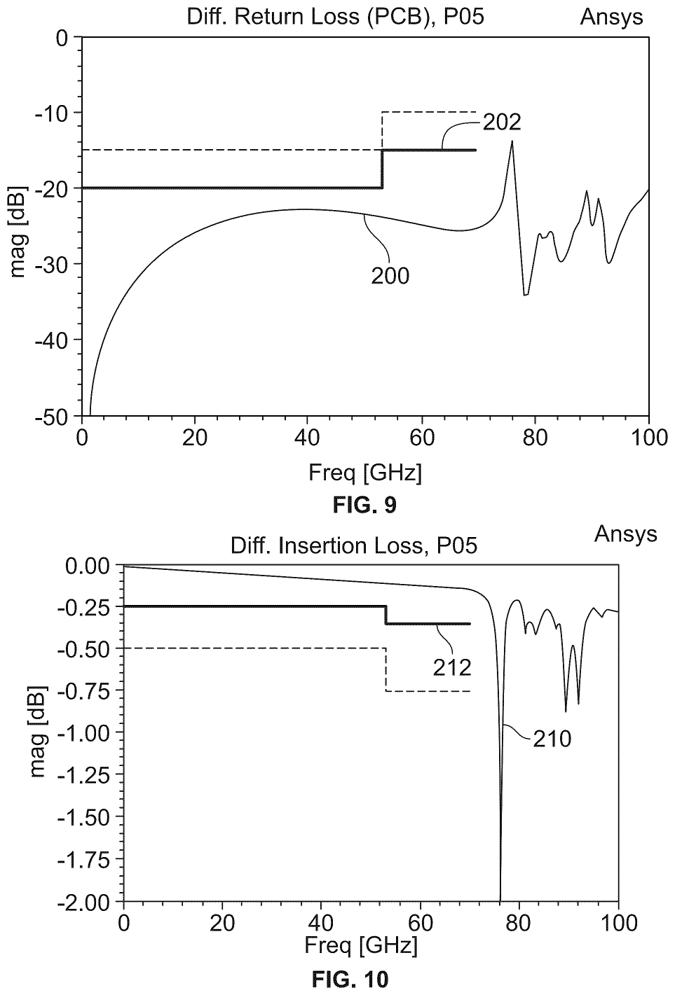

FIG. 9 is a graph illustrating return loss 200 of the socket connector 100 including the resonance control structure 120 showing limit lines 202 for an exemplary socket connector 100. The results show that the socket connector has sufficient return loss electrical performance in the socket connector 100. For example, the return loss 200 remains below the limit lines 202 in the target frequency range, such as beyond 60 GHz.

FIG. 10 is a graph illustrating insertion loss 210 of the socket connector 100 including the resonance control structure 120 showing limit lines 212 for an exemplary socket connector 100. The results show that the socket connector has sufficient insertion loss electrical performance in the socket connector 100. For example, the insertion loss 210 remains above the limit lines 212 in the target frequency range, such as beyond 60 GHz.

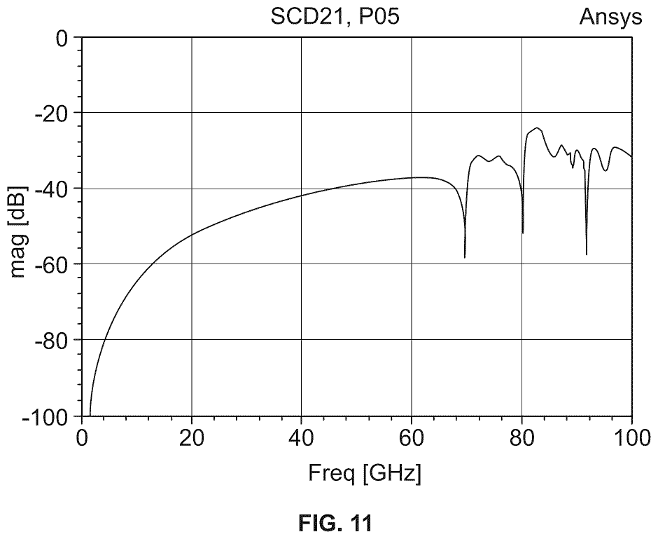

FIG. 11 is a graph illustrating common mode conversion to insertion loss ration (SCD21) 220 of the socket connector 100 including the resonance control structure 120. The results show that the socket connector has sufficient SCD21 electrical performance in the socket connector 100. For example, the SCD21 does not include any peaks or dips outside of specifications in the target frequency range, such as beyond 60 GHz.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A socket connector comprising:
a substrate having an upper surface and a lower surface, the substrate including contact channels between the upper and lower surfaces, the substrate including pockets between the upper and lower surfaces, the pockets located between corresponding contact channels;
socket contacts received in corresponding contact channels, each socket contact including a contact body, an upper mating element, and a lower mating element, the upper mating element extending to the upper surface to interface with a first electrical component, the lower mating element extending to the lower surface to interface with a second electrical component; and
lossy inserts received in the pockets, the lossy inserts being manufactured from lossy material capable of absorbing electrical resonance propagating through the substrate, the lossy inserts being discrete from the substrate and being located in the pockets of the substrate in proximity to the socket contacts.

2. The socket connector of claim 1, wherein the substrate separates the pockets from the contact channels.

3. The socket connector of claim 1, wherein the lossy inserts are coplanar with the upper and lower surfaces or recessed interior of the upper and lower surfaces.

4. The socket connector of claim 1, wherein the lossy inserts are manufactured from lossy material.

5. The socket connector of claim 1, wherein the lossy inserts include lossy material providing electric and/or magnetic loss through a portion of the substrate.

6. The socket connector of claim 1, wherein the lossy inserts include a dielectric binder material and conductive fillers dispersed within the dielectric binder material.

7. The socket connector of claim 6, wherein the lossy material includes the filler material at an amount up to 50% by volume.

8. The socket connector of claim 1, wherein the socket contacts include signal socket contacts and ground socket contacts, the signal socket contacts being arranged in pairs, the ground socket contacts surrounding the pairs of signal socket contacts.

9. The socket connector of claim 1, wherein the socket contacts include signal socket contacts and ground socket contacts, the socket contacts being arranged in pair groups, each pair group having a pair of the signal socket contacts surrounded by ground socket contacts forming a shield box around the pair of signal socket contacts, the lossy inserts being arranged between corresponding pair groups.

10. The socket connector of claim 9, wherein the lossy inserts are aligned with the pairs of signal socket contacts.

11. The socket connector of claim 9, wherein the pair groups have a width, the lossy inserts having an insert width less than the width of the pair group.

12. The socket connector of claim 1, wherein the socket contacts are arranged in rows, the lossy inserts being arranged between corresponding rows of the socket contacts.

13. The socket connector of claim 12, wherein the socket contacts are arranged in columns, the lossy inserts being arranged between corresponding columns of the socket contacts.

14. The socket connector of claim 1, wherein the upper mating elements are deflectable and define a separable mating interface with the first electrical component.

15. The socket connector of claim 14, wherein the lower mating elements are deflectable and define a separable mating interface with the second electrical component.

16. A socket connector comprising:
a substrate having an upper surface and a lower surface, the substrate including contact channels between the upper and lower surfaces, the substrate including pockets between the upper and lower surfaces, the pockets located between corresponding contact channels;
socket contacts received in corresponding contact channels, each socket contact including a contact body, an upper mating element, and a lower mating element, the upper mating element extending to the upper surface to interface with a first electrical component, the lower mating element extending to the lower surface to interface with a second electrical component, wherein the socket contacts include signal socket contacts and ground socket contacts, the socket contacts being arranged in pair groups, each pair group having a pair of the signal socket contacts surrounded by ground socket contacts forming a shield box around the pair of signal socket contacts; and
lossy inserts received in the pockets, the lossy inserts being manufactured from lossy material capable of absorbing electrical resonance propagating through the substrate, the lossy inserts being separate and discrete from the substrate and being attached to the substrate in the pockets in proximity to the socket contacts, wherein the lossy inserts are in proximity to each pair group.

17. The socket connector of claim 16, wherein the lossy inserts are arranged between rows of the pair groups.

18. The socket connector of claim 16, wherein the lossy inserts are arranged between columns of the pair groups.

19. A socket connector comprising:
a substrate having an upper surface and a lower surface, the substrate having a molded body molded from a low loss dielectric material, the substrate including contact channels between the upper and lower surfaces, the substrate including pockets between the upper and lower surfaces, the pockets located between corresponding contact channels;
socket contacts received in corresponding contact channels, each socket contact including a contact body, an upper mating element, and a lower mating element, the upper mating element extending to the upper surface to interface with a first electrical component, the lower mating element extending to the lower surface to interface with a second electrical component; and
lossy inserts molded in place in the corresponding pockets of the substrate, the lossy inserts being manufactured from lossy material capable of absorbing electrical resonance propagating through the substrate, the lossy inserts located in proximity to the socket contacts.

20. The socket connector of claim 19, wherein the socket contacts include signal socket contacts and ground socket contacts, the socket contacts being arranged in pair groups, each pair group having a pair of the signal socket contacts surrounded by ground socket contacts forming a shield box around the pair of signal socket contacts, the lossy inserts being arranged between corresponding pair groups.
